(19) United States
(12) Patent Application Publication
(10) Pub. No.: US 2017/0148399 A1
(43) Pub. Date: May 25, 2017

(54) SCANNING METHOD FOR A DISPLAY DEVICE

(71) Applicant: Pricer AB, Stockholm (SE)

(72) Inventor: George Melnik, Montrose, NY (US)

(21) Appl. No.: 15/129,599

(22) PCT Filed: Apr. 17, 2014
(86) PCT No.: PCT/SE2014/050477

§ 371 Date: Sep. 27, 2016

(51) Int. Cl. G09G 3/36

(52) U.S. Cl. CPC G09G 3/3618; G09G 3/3666; G09G 3/3614; G09G 2320/0209; G09G 2310/08; G09G 2310/0202; G09G 2330/021

(57) ABSTRACT

An electronic shelf label that includes a casing, a display arranged in the casing, a printed circuit board, enclosed by the casing, a power source, and a thermal element arranged within the casing.

### FIELD OF THE INVENTION

The present invention relates generally to the field of active matrix liquid crystal displays, and more particularly to an addressing method for driving an active matrix liquid crystal display and a corresponding display device.

### BACKGROUND OF THE INVENTION

Active matrix liquid crystal displays (AMLCDs) are known in the art, and generally include row and column address lines which are horizontally and vertically spaced apart and cross at an angle to one another thereby forming a plurality of crossover point pixels which can be selectively addressed by the application of suitable potentials between respective pairs of the row and column address lines. Active Matrix (AM) addressing methods can be achieved by incorporating a nonlinear control element, like a switch, in the cross point of the row and column lines (in series connection) of each pixel. Thin film transistors (TFTs) are typically arranged to act as switching elements for energizing or otherwise addressing corresponding pixels electrodes. The use of a switch will provide a 100% duty ratio for the pixel by using the charge stored at the pixel during the row addressing time. The switch is typically controlled by two pulse signals which are produced by external driving circuits, the row and column drivers. Matrix addressed displays may be addressed one line at a time, i.e. the rows are scanned in sequence by a select gate pulse governed by a scan clock (CKV) during a frame time. The gate pulse of the selected row will turn “ON” the switch TFT of each pixel and simultaneously, the storage capacitor will be charged with the image data (voltage) provided from the column driver. After the row time, herein after referred to as the line timing LT, has passed the switch TFT is turned “OFF” as soon as the negative edge of the row gate pulse is delivered and the pixel will be isolated from column driver until the next frame time when the image data is refreshed.

In normal display operation, and specifically HDTV application, LCD image frames are refreshed a minimum of 60 frames/second for application to video presentation. The eye perceives continuous motion because the images are changed faster than the response of the human eye. Reduced power consumption in AMLCDs is commonly achieved through application of low frequency refreshing. The already low power consumption of the AMLCD, without a backlight, can then be reduced by nearly 2 orders of magnitude simply by choosing a refresh of only once per second and therefore lending itself directly to long life battery operation. If the display application only requires static, and preferably binary images, the refresh frequency (RF) may even be reduced to lower frequencies to conserve even more power.

The simplest method of employing reduced refresh frequency RF is to slow the scan clock (CKV). In this case, the duty cycles of all lines, particularly the gate address lines, remains the same but simply operates at lower frequency. As the display itself is a simple capacitor, this can work well for power consumption unless parasitic and leakage currents are high. The system described above is generally effective in accomplishing a sufficient power reduction of a display. However, there is a need for an improved refresh scanning method with high efficiency. To achieve such operation, scanning methodology, or refresh scan modes, and LC operating modes, must be employed to reduce the visibility of each frame scan. Herein, we propose scanning methods that will reduce the visibility of frame or line refresh scan modes, and potentially improve LCD lifetime under low power operation.

### SUMMARY OF THE INVENTION

It is an object of the present invention to at least provide an improved refresh scanning method with high power efficiency.

In accordance with a first object of the invention, there is provided a method of driving a display of active matrix-type. The matrix includes addressable pixels associated with lines L₁-L_{M} and columns of the matrix. The method comprises: writing image data to the matrix utilizing a line timing LT determined by a preselected base frame rate BR and the number of lines M of the matrix, determining an extended frame rate N-frame for addressing all pixels of the matrix, and providing a preselected intermittent refresh IR by distributing the writing of image data to all pixels within a time period defined by the extended frame rate N-frame. The proposed method of refresh involves maintenance of the same or faster line timing as is present in a 60 Hz LCD module while simultaneously employing intermittent refresh. With the intermittent refresh scanning method the maintained fast line timing results in a reduction in the duty cycle of the gate line. Thus the gate line anneal (negative voltage condition), where electrons are expelled from the channel region of the TFT, is extended, resulting in potentially better TFT aging conditions during the life of the panel.

Further, in addition to providing lowest possible gate degradation, maintenance of the fast line timing, i.e. fast scan times, advantageously results in low visibility of the image refresh, in particular, using the fast scan mode (which is described in more detail below). This in turn results in the potential application of existing AMLCD TFT backplanes to low power consumption static image applications like price tag display etc. without major modification.

According to an embodiment of the method, the extended frame rate N-frame is based on a selected refresh constant N. The refresh constant N is selected to provide a low intermittent refresh which in turn lowers the power consumption of the display, while providing sufficiently low visibility, i.e. a lowest possible refresh rate where the refresh scans remain invisible. The extended frame rate N-frame is determined by the product of the refresh constant N and the base rate BR according to N-frame=N·BR, where BR is defined by the time required to address M+O lines, where 0 is the display over scan.

According to an embodiment of the method, the refresh constant N is determined based on the image data.

According to an embodiment of the method, the refresh constant N is selected based on crosstalk associated with the image data. Increasing the value of the refresh constant N for images that exhibit lower crosstalk will increase power savings while the refresh scan remains invisible. For example, black on white image data commonly exhibits lower crosstalk values than the inverse.

According to an embodiment of the method, which is hereinafter also referred to as fast scan mode, the step of distributing writing of image data comprises: addressing all lines L₁-L_{M} in sequence during a 1^{st} frame, holding a predetermined number of frames defined by the refresh constant N, and then refreshing the image data by addressing all lines L₁-L_{M} in sequence during an N^{th} frame. The fast scan mode advantageously provides 60 Hz or faster single frame refresh scanning for reduced visibility. Due to the long hold period (N base rate frames) between writing to the display, advantageously and according to an embodiment of the method, a quiescent state, optionally governed by a sleep timer, which preferably is defined by the hold time associated to the refresh constant N, is applied to the driving electronics during the hold period in order to maximize power savings.

According to an embodiment of the method, which is hereinafter also referred to as full frame slow scan mode, the method further comprises a step of determining a line clock time CKV. The step of distributing writing of image data comprises: addressing all lines L₁-L_{M} in sequence, while holding/waiting a number of CKVs determined by the refresh constant N before addressing a subsequent line, which is advantagous to provide reduced refresh visibility.

According to an embodiment of the method, which is hereinafter also referred to as segmented frame slow scan mode, the step of distributing writing of image data comprises: dividing the matrix into M/N scan segments, and for each succesive frame addressing a subsequent line of each scan segment until all lines have been addressed, which is advantagous to provide reduced refresh visibility.

Both the full and segmented frame slow scan modes are conducive to battery operated labels. Even though the charge delivered from the battery to the display is effectively the same as for other displays, the slow scan modes provide lower average driving currents of the display, which in turn can result in longer lived batteries depending on battery chemistry. Slow scan modes may also be advantageous to certain images such as those with low spatial frequency transitions, further suppressing refresh visibility when used.

According to an embodiment of the method, the method further comprises utilizing frame inversion, column inversion, line inversion, or pixel inversion during the intermittent refresh. This adds spatial averaging of any flicker visibility on the display. A properly selected inversion scheme will exhibit the lowest crosstalk with the lowest flicker visibility.

According to an embodiment of the method, the intermittent refresh is also performed in the same polarity for a selected number of N-frames, which provides further improved power savings. The most common method in the prior art is to invert polarity at each refresh. This consumes more power because each pixel capacitor requires the greatest current to invert polarity. To refresh in the same polarity requires substantially less current and provides an opportunity to refresh the image returning is to its undegraded state. The use of same polarity refresh is preferably balanced, such that the display is not harmed. That is, an equal number of same polarity frames are used in both positive and negative polarity for each image. A maximum balanced number of these same polarity refresh frames can result in maximum power savings. That number depends on display chemistry and construction and can be determined by testing.

According to an embodiment of the method, the intermittent refresh further comprises successive same polarity base rate frame pixel charging, which is advantageous to achieve maximum charge stability.

According to an embodiment of the method, the successive base rate frame pixel charging is performed only in each inverting frame. Using the fast scan mode embodiment described above, a preselected number of same polarity base rate frames is addressed when polarity is inverted at the beginning of each N-frame. Using the slow mode embodiments, multiples lines are addressed and readdressed.

According to a second aspect of the invention, there is provided a display device employing the addressing method according to the present invention having the same advantages as discussed above with reference to the first aspect of the invention.

### BRIEF DESCRIPTION OF THE DRAWINGS

The invention will now be described in more detail and with reference to the appended drawings in which:

FIG. 1 is a schematic illustration of an embodiment of a method according to the present invention utilizing fast scan mode;

FIG. 2 is a schematic illustration of an embodiment of a method according to the present invention utilizing a full frame slow scan mode;

FIG. 3 is a schematic illustration of an embodiment of a method according to the present invention utilizing a segmented frame slow scan mode;

FIG. 4 is a schematic illustration of an embodiment of a method according to the present invention utilizing a full frame slow scan mode with successive base rate frame same polarity pixel charging;

FIG. 5 is a schematic illustration of an embodiment of a method according to the present invention utilizing a slow scan mode with successive base rate frame same polarity pixel charging;

FIG. 6 is a schematic illustration of an embodiment of a method according to the present invention utilizing a full frame slow scan mode with successive base rate frame same polarity pixel charging; and

FIG. 7 shows crosstalk measurements indicating image dependent crosstalk and varying N depending on image.

### DESCRIPTION OF PREFERRED EMBODIMENTS

The present invention will now be described more fully hereinafter with reference to the accompanying drawings. The below embodiments are provided by way of example so that this disclosure will be thorough and complete, and will fully convey the scope of the invention to those skilled in the art. Like numbers refer to like elements throughout.

### Nomenclature:

Refresh constant, N, is a constant chosen to provide a desired extended frame time according to the inventive concept.

Base rate, BR, is the fastest timing utilized in shown scan modes herein. In the following embodiments of the present inventive concept, the base rate is selected to be 60 Hz. According to alterative embodiments, the base rate can also be chosen to be faster or slower for best performance of a specific display type being used.

Lines times, LT, are fixed in all scan modes and are determined by the base rate BR divided by the number of lines M in the matrix plus over scan O:

LT=BR/(M+0) Eq. 1.

N-frame is the frame rate determined by the time it takes to address every pixel in the LCD matrix. N-frame is set to N times the base rate BR in some examples herein, but can also be selected based on e.g. the image data or crosstalk. If N=60 and the base rate BR is selected to be 60 Hz, the N-frame is 1 second which corresponds to an intermittent refresh rate IR of 1 Hz.

N-frame=N·BR Eq. 2.

According to the current inventive concept, fast line address times that are equal to or faster than those used in 60 Hz, video compatible LCD displays are utilized when writing data to the LCD matrix, while an intermittent refresh is provided. As previously mentioned, maintaining fast refresh times is advantageous for reduced visibility, analogous to video operation, for both frame and line scan modes. Herein three scan modes: fast scan, full frame slow scan and segmented frame slow scan are proposed.

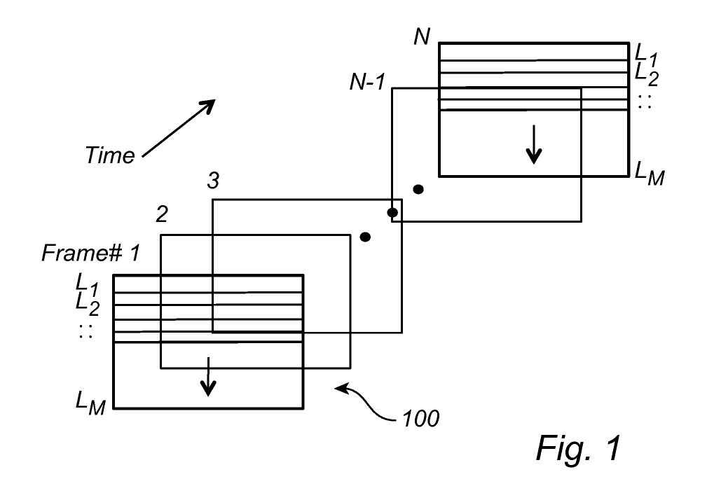

Fast scan: Fast scan utilizing 60 Hz or faster single frame refresh scanning for reduced visibility is proposed. Referring now to FIG. 1, a schematic illustration of an embodiment of a method according to the present invention utilizing fast scan mode is shown. The matrix 100 of a display including addressable pixels associated with lines L₁-L_{M} and columns is scematically illustrated showing the lines L₁ -L_{M}. In FIG. 1 a number of base rate frames (#) 1 to N distributed over a time period of N times the base rate BR (corresponding to the extended frame time N-frame) illustrate line addressing when writing image data to the matrix 100. A line timing LT determined by the base rate BR and the number of lines M of the matrix according to Eq. 1 is employed. During frame #1 information is written in a single base rate (60 Hz) scan of the entire display. The image data is then held for a predetermined time defined by the refresh constant N, before it is refreshed by writing image data in a single base rate (60 Hz scan) of the entire display during frame #N. The extended frame rate N-frame for addressing all pixels of the matrix is governed by Eq. 2 and the intermittent refresh IR is provided by means of distributing the writing and refreshing of image data to all pixels within the defined extended frame rate N-frame.

The refresh constant N can be selected as any integer. According to an embodiment of the method the refresh constant N is matched to a currently used base rate BR. In the exemplifying embodiment, the refresh constant is selected to be N=64 (01000000) which approximately corresponds to an N-frame of 1 second between refreshing scans. According to embodiments of the method of the present invention, the value of the refresh constant N is determined by image information. In accordance with the inversion methods, many images will exhibit different degradation depending on distribution of the information, i.e. image data, over the matrix. Values of N are can be previously measured and then presented with each of the images, e.g. by retrieving data stored in a data base, in order to further maximize power savings. In another embodiment of the method according to the present invention, a value of N can be estimated by the maximum pixel density of white and black pixels and the ratio of the two states over the entire display surface. A look up table is provided that determines a value N based on these parameters for each image.

In alternative embodiments, the N-frame length is varied based on image data and polarity inversion. Polarity inversions schemes with low crosstalk, such as frame or column inversion will have large N values. The N value utilized will automatically take this into account if the values are measured. A multiplier can also be associated with certain polarity schemes for the purposes of estimation.

According to embodiments of the fast scan mode, in conjunction with the fast line addressing, frame inversion is employed when refreshing the image data to enable the lowest possible charge accumulation in either polarity. Referring again to FIG. 1, during the first 60 Hz base rate frame all lines are addressed in the allotted 16 ms. The next N-1 frames are blank. The display is then refreshed in opposite polarity again at the pre-programmed N+1^{th} frame. Since every other addressed frame inverts polarity and the value of the refresh constant N is fixed for every image LC driving is balanced and any opportunity for image retention is minimized.

According to an embodiment of the method of the present invention, in conjunction with the fast mode scan, same polarity refresh frames are also employed. This is based on the display tolerance for charge accumulation of either polarity. If the tolerance is high than a larger number of same polarity refresh frames can be used, thus conserving more power.

According to an embodiment of the method of the present invention, in conjunction with the fast scan mode, successive frame same polarity pixel charging to achieve maximum charge stability is employed.

According to an embodiment of the method of the present invention, in conjunction with the fast scan mode, successive frame pixel charging to achieve maximum charge stability is employed in each inverting frame.

According to an embodiment of the method when utilizing the fast scan mode, to maximize power savings, a fixed number of same polarity images are refreshed before inverting the polarity of the image.

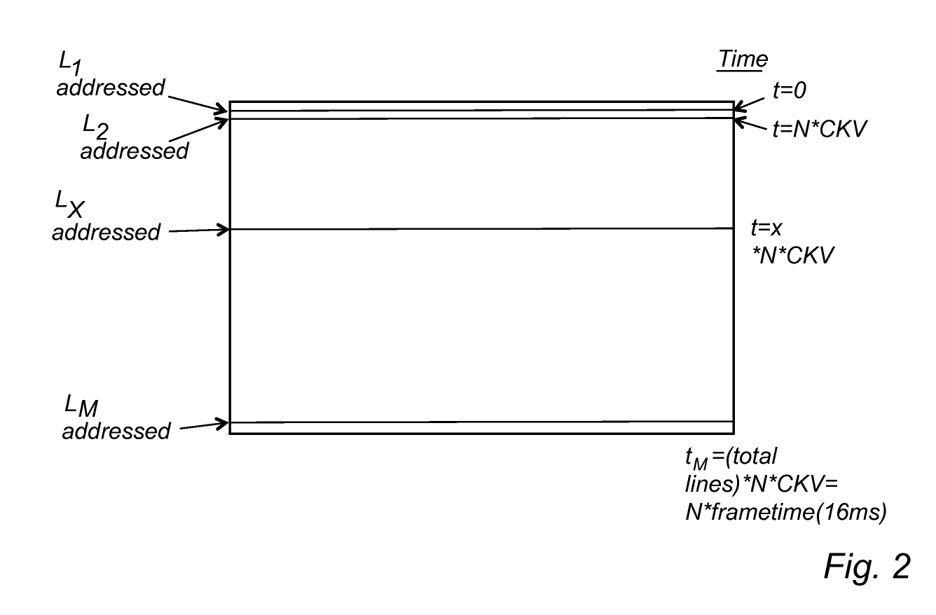

Full Frame Slow Scan Mode: Referring now to FIG. 2 which is a schematic illustration showing a matrix 200 of a display including addressable pixels associated with lines L₁-L_{M} and columns where lines L₁ -L_{M} are schematically illustrated. According to an embodiment of the method of the present invention, a full frame slow scan mode is employed. Each frame is divided equally in time for each of the lines L₁ -L_{M} (rows) in the display. A timing controller device of the LCD (Tcon) generates a line clock CKV equal to this time division that addresses each line in the display. In the full frame slow scan mode, the refresh constant N as described above determines the number of CKVs which are skipped between addressing the next line. Thus if N=64, 64 CKVs pass after addressing line L₁ before addressing line L₂, etc. and therefore 64 frame times, corresponding to the N-frame, pass by the time the entire display is scanned. This mimics the prior art solution of simply slowing the display clock to provide a low frequency refresh, except each line is addressed in the same line timing it would be addressed at the base rate (60 Hz), regardless of the value of refresh constant N. In FIG. 2 the time line is represented on the right of the figure. At time t=0 the first line L₁ of the display is addressed. If the display has 200 lines, i.e. M=200, (ignoring over scan) then each line is addressed in 80 um (base rate line time). Maintaining the N=64 example, then line L₂ is addressed in the next 80 us increment after N·80 us=5.12 ms and all 200 lines are addressed after 200.64·80 us=200·5.12 ms=64·16 ms=1.024 s. 5.12 ms after line L₂₀₀ is addressed line L₁ begins the next scan. As discussed above, this reduces the duty cycle on the gate lines by the same factor of N. This results in better gate behavior and reduces device threshold drift by trapping fewer electrons in the TFT channel.

Segmented Frame Slow Scan Mode: According to an embodiment of the method, a segmented frame slow scan mode is employed. The segmented frame slow scan mode is similar to the full frame slow scan mode except that instead of waiting N CKVs before addressing the next adjacent line in the display, N lines are skipped before the next line is addressed. Since the CKV is defined by the number of lines M and the 60 Hz frame time, the total number of lines divided by the refresh constant N, M/N, are addressed in each 60 Hz frame spaced equally by N lines. In the next 60 Hz frame each line adjacent to lines just addressed is addressed and therefore after N frames every line in the display is finally addressed.

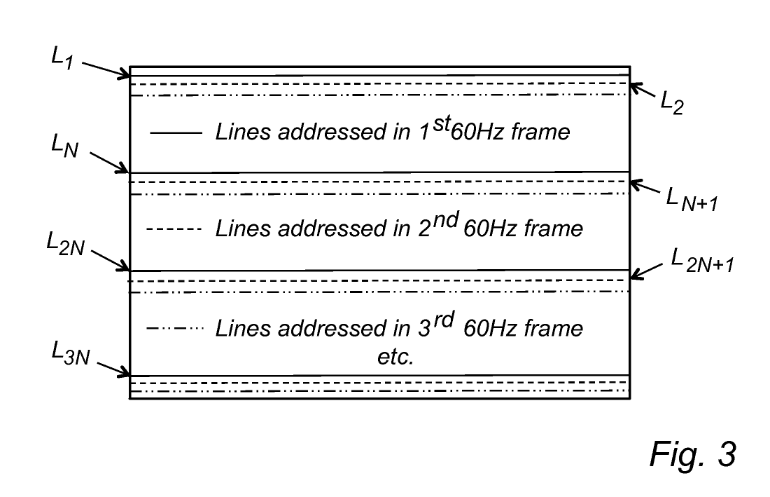

FIG. 3 represents the operation of the segmented frame slow scan mode schematically. Maintaining the example of N=64, the 200 line display is broken into 3 equal segments of 64 lines, the remaining segment contains only 8 lines. The first line in each segment is addressed in the first 60 Hz frame. Similar to the full frame slow scan mode example using this display, line L_{N} is address N·80 us=5.12 ms after line L₁, then line L_{2N} and L_{3N} each separated equally in time, completing the first 60 Hz frame. Lines L₂, L_{N+1}, L_{2N+1}, and L_{3N+1} are all addressed in the second 60 Hz frame. At completion of the N^{th} 60 Hz frame all lines in the display have been addressed. The next slow scan mode frame begins immediately with line L₁ in the next 60 Hz frame.

In accordance with the present invention, for the described scan modes above, polarity and inversion methods are utilized in embodiments thereof, which can also affect the visibility of the frame or line refresh scan modes, in addition to contributing to lowering the power consumption. Maintaining the same polarity in multiple refresh cycles before inverting contributes to power savings because the current consumption is directly proportional to the voltage difference in the addressed pixel (pixel capacitor). Thus if leakage is low in the pixel and the same polarity is used to refresh the image, no power is consumed in the display.

According to embodiments of the method, low crosstalk polarity inversion methods are employed for longer hold times, which results in even lower power consumption. Frame inversion commonly exhibits the lowest crosstalk because all pixels are charged in the same polarity in each frame. This method can also result in high refresh visibility because of asymmetric driving conditions, particularly if leakage is high. Column, row or pixel inversion can reduce this visibility but increases crosstalk, thus reducing hold times and consuming more power.

### Contributions to Image Degradation

In its simplest form, each pixel is modeled as an independent capacitor. A voltage applied to this capacitor can be stored indefinitely under ideal conditions. Thus ideally an image would not degrade over time and therefore rewriting the same image would be truly invisible. In practice, this is not the case due to leakage and/or crosstalk.

Leakage: The TFT itself has a finite, and measurable, off current. While this current is very small, typically 10⁻¹³A, it is sufficient to contribute to a degradation of the voltage stored on the pixel capacitor between refreshing frames. Other leakage paths also exist due to the close proximity of addressing lines and the finite resistivity of the materials isolating these lines from the pixel electrode. Most commonly leakage is attributed to a decay of the voltage stored on the pixel toward ground as ground is chosen as the reference voltage used by the storage capacitor.

Crosstalk: Crosstalk occurs when the image being written in one part of the display affects the image in another part of the display. All information transmitted on the column lines to other pixels can affect the voltage on the isolated pixel capacitors in another part of the image. Here the line between the definitions of crosstalk and leakage can become blurred. Without a leakage path of the voltage on the pixel capacitor to the lines used to address all other pixels there would be no crosstalk. In nominal 60 Hz operation, a display will exhibit a different brightness in the image field in the center of the display between the two boxes of different brightness level then on the sides of the image where the boxes are not patterned. The boxes are aligned top and bottom in order to create a sharp transition in the background field.

The definitions of crosstalk and leakage can become even more blurred when the scan rate is reduced well below 60 Hz where the image, when actively written elsewhere in the display, will affect the image at some position of interest. In these cases the combination of the two effects (crosstalk and leakage) can act to change the brightness at the measurement position.

Incomplete Pixel Charging: A voltage is applied to each pixel only when the gate line is high. This pulse is active for ˜10 us. The LC material on the other hand will take from 2-10 ms to respond to this change in voltage. An increase in voltage across the LC material causes a reorientation of the LC material which increases the dielectric constant of the pixel capacitor (ε_{II}>ε_{I}), and therefore its capacitance, thus reducing the voltage across the pixel. This change in voltage can be a full factor of 2 or greater. Subsequent refresh frames for the same image will add more voltage to the pixel capacitor eventually fully charging the pixel, but if these frame are delayed in order to save power the image quality will suffer during this change.

A sufficiently large storage capacitor will also mitigate this degradation although it can never completely eliminate it. Another option is to address more than one frame at the nominal 60 Hz refresh rate when changing the image.

Asymmetry of positive and negative frames: The optical response of the LC is commonly not the same when addressed at the same magnitude but in opposite polarity. When addressed at sufficiently high refresh rates (60 Hz and greater) the eye perceives the average brightness of these levels, but when slowed, flicker can be perceived. Crosstalk is a major contributor to this asymmetry but there are many other causes. Asymmetry of the TFT ON current can be a problem particularly for the positive frame. As the voltage to be applied to the pixel nears the magnitude of the gate pulse, threshold effects will also play a role. Furthermore the cell gap itself may contribute a screening potential to the LC material. The organic materials which make up the cell gap of the pixel capacitor contain ions of both polarities with different migration rates and trapping coefficients. Depending on these chemistries even small amounts of DC on a pixel may result in development of a screening potential. To make matters worse the screening potential can be dynamic in nature; increasing or decreasing in time depending on external conditions.

The single best way to hide this asymmetry is to utilize pixel and line inversion schemes. According to an embodiment of the method of the present invention, inversion schemes are utilized by always driving half the pixels on the display screen, i.e., the matrix, in opposite polarity in each (writing) frame. This adds spatial averaging to the time averaging of high refresh rates to fully suppress flicker visibility. These methods also induce more crosstalk because of the larger voltage differential between pixels in the same frame.

LC Voltage Sensitivity: Typical LCDs on the market today are designed normally white. The image is bright when no or low voltage is applied to the LC material. At higher voltage the LC is driven to its black state. A 90 degree twisted nematic is commonly employed as the optical modulator.

With all the potential for asymmetric driving conditions discussed above, some form of flicker may always be visible no matter what is done to ensure voltage symmetry. To suppress the visibility of this asymmetry the sensitivity of the dark state to variations in potential should be made as large as possible. The 90TN mode is not ideal but there are “thresholds” associated with both the black and white states which reduce sensitivity. In the white state on a 90TN there exists a voltage threshold which must be exceeded before the LC begins to reorient into the electric field. Most LC materials exhibit this threshold at approximately 1V. In the dark, high voltage state, once the LC has effectively fully reoriented in the electric field, the slope of the brightness response to voltage drops significantly. The sensitivity of this state depends on actual dark state drive voltage. If this voltage is sufficiently beyond the change in slope of the brightness response curve, it can be considered an effective threshold.

Successive Same Polarity Frame Addressing: Upon inversion, pixels will not charge to their full potential due to the slower LC reorientation, as was described above under the paragraph Incomplete Pixel Charging. This assumes some degradation of the LC orientation has occurred or the image information has changed. As the LC reorients the pixel capacitance changes. If the reorientation is toward the field direction the capacitance increases and the voltage determined by the charge stored during the initial address decreases.

According to the invention, regardless of the scan mode selected (fast-, full frame slow-, segmented frame slow-), there are effectively N frames available where no pixels on the LCD are addressed, therefore, in any successive frame, a pixel previously written can be readdressed during this time. If this is done in the same polarity, additional power consumption is minimal and, the desired pixel charge is ensured. This is referred to as successive base frame rate same polarity pixel charging, and is advantageous after polarity inversion or an image change, especially when driving to black in a normally white LCD. Ensuring all pixels are fully charged in black can result in longer hold times due to better charge stability and therefore additional power savings, especially over long periods of operation.

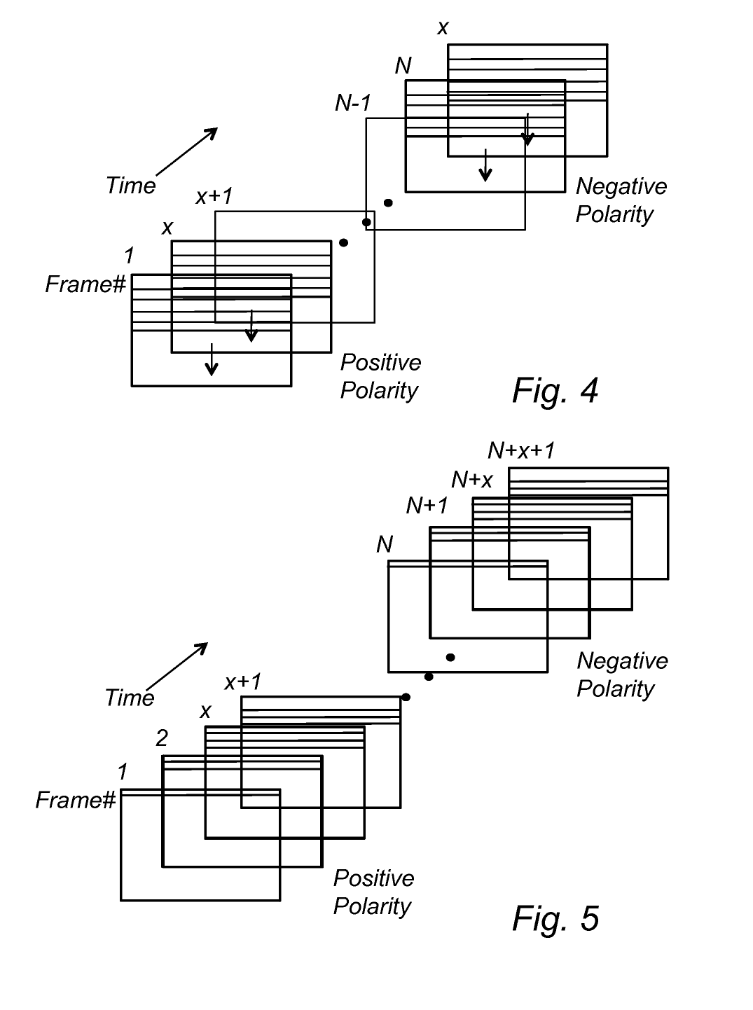

Referring now to FIGS. 4 and 5, embodiments of the present invention with the successive base frame rate same polarity pixel charging, i.e. addition of same polarity frames at the base frame rate to more fully charge the pixels is described in more detail herein under. As discussed, this is most useful for black image information where a change in the optical response of the LC at sufficiently high voltage behaves as a threshold.

FIG. 4 shows the use of successive same polarity base rate frames in the fast scan mode. The threshold constant N is selected to effectively provide a hold time in this mode. Further, multiple base rate frames (defined by x in FIG. 4) can be addressed in the same polarity prior to the hold time. This will ensure full charging of all pixels to their desired level and can be used with all inversion schemes: frame, column, row, and pixel. In FIG. 4 the first frame #1 is addressed in “positive” polarity. The following x base rate frames are addressed in the same polarity. The figure shows only two frames but this number can be chosen for best operation. It should be no more than, but not limited to, a small fraction of the total number of frames defined in the N-frame.

In the slow scan modes the base rate frame time (BR) is divided into line times (CKV) determined by the number of lines in the display and the number of “lines” that define the top and bottom over scan: CKV=BR/(lines+over scan). Therefore the N-frame line time can be considered N·CKV. In the full frame slow scan mode as explained earlier with reference to FIG. 2, there is no readdressing in the same polarity. Each line is addressed in one CKV and then a hold time of N·CKV is used before the next line is addressed. In the full frame slow scan mode the next line is the next line in the sequence (a->a+1) where “a” is the line number just addressed.

FIG. 5 is a schematic illustration of an embodiment of a method according to the present invention utilizing a full frame slow scan mode with successive base frame rate same polarity pixel charging. One successive base frame rate charging example (x=3) is provided. In a first base frame only line L₁ is addressed. It is then readdressed in each of x next successive base frames in the same polarity. In the next N-frame each line is again addressed in sequence with x successive readdressings, but with an opposite polarity.

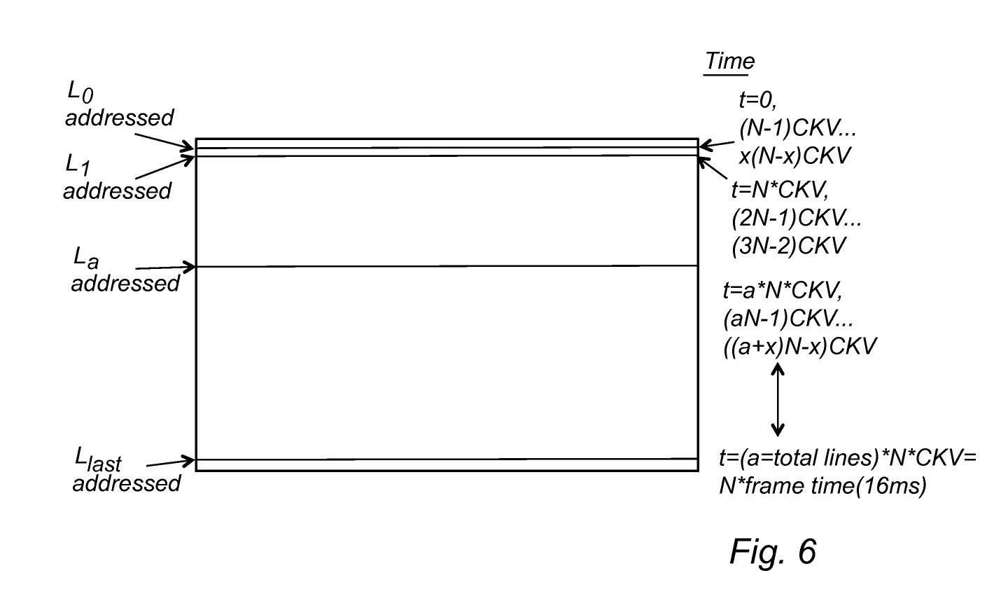

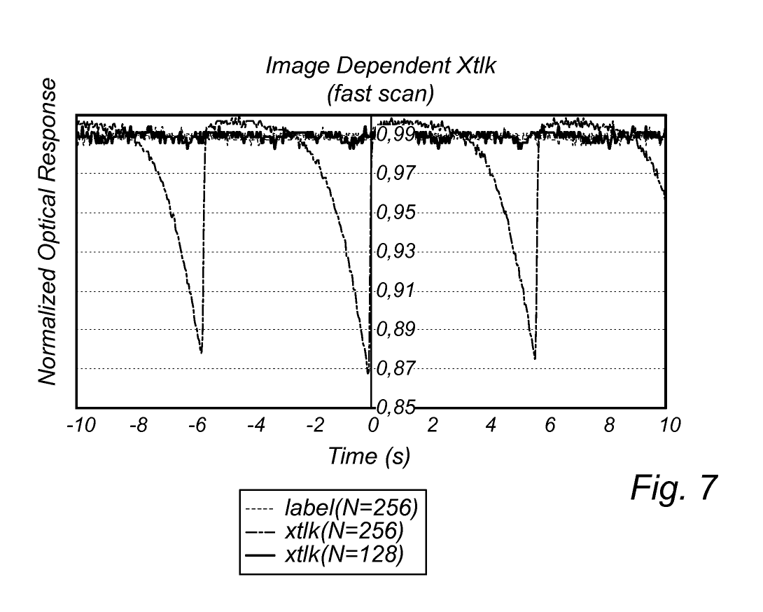

In the segmented frame slow scan mode the next line is the first line in the next scan segment (a->a+N). The successive base rate line addressing takes advantage of the N·CKV hold time by using it to readdress previously addressed lines in the same polarity. The number of times a line is readdressed can again be defined as x. FIG. 6 shows the timing for the full frame slow scan mode on the right of the diagram. The timing sequence for the segmented frame slow scan mode is identical to that of the full frame slow scan mode, and only the lines which are readdressed change. Selecting now the x CKVs just prior to addressing the a^{th} line for readdressing the x lines above a, the timing sequence for initial addressing and readdressing (a timing sequence for writing and refreshing) of the a^{th} line is given by, t=((a+x)N−x)CKV, for x=0 to x−1. The line timing sequence for x=3 is shown in Table 1

TABLE 1
Time (•CKV)

| | | | | | | | |
|---|---|---|---|---|---|---|---|
| Line | L₀ | 0 | N-1 | 2N-2 | | | |
| | L₁ | | N | 2N-1 | 3N-2 | | |
| | L₂ | | | 2N | 3N-1 | 4N-2 | |
| | L₃ | | | | 3N | 4N-1 | 5N-2 |
| | L₄ | | | | | 4N | 5N-1 |
| | L₅ | | | | | | 5N |

From Table 1, it can be seen that the first line (a=0) is addressed at t=0. The second line (a=1) is addressed at N·CKV and 1 CKV before that the first line is readdressed at (N−1) CKV. The third line (a=2) is addressed initially in this N-frame at 2N·CKV. One CKV clock cycle before that the second line is readdressed for the first time at (2N−1)CKV and the first line is readdressed for its 3^{rd} and last line just prior to that at (2N−2)CKV. When the 4^{th} line is addressed at 3N·CKV the 2^{nd} and 3^{rd} line are readdressed in the previous 2 clock cycles but line 1 is no longer readdressed as it has already been addressed 3 times.

TABLE 2
Time (•CKV)

| | | | | | | | |
|---|---|---|---|---|---|---|---|
| Line | L₀ | 0 | N-1 | 2N-2 | | | |
| | L_{N} | | N | 2N-1 | 3N-2 | | |
| | L_{2N} | | | 2N | 3N-1 | 4N-2 | |
| | L_{3N} | | | | 3N | 4N-1 | 5N-2 |
| | L_{N+1} | | | | | 4N | 5N-1 |
| | L_{2N+1} | | | | | | 5N |

The timing sequence is identical for each scan segment in the segmented frame slow scan mode and only the line numbers change. Line L₁ becomes line L_{N} and line L₂ becomes line L_{2N}, etc. In order to draw the timing table for this mode the total number of lines in the display and the value of N must be predefined. Choosing N=64 and M=200 the timing table for the segmented frame slow scan mode is as follows in Table 2.

Referring now to FIG. 6, crosstalk measurements indicating image dependent crosstalk and varying N depending on image is illustrated. In this exemplifying illustration images showing a price label, see FIG. 6, were measured with respect to crosstalk Xtlk, when utilizing a fast scan mode according to the present invention with two different refresh constants N₁ and N₂. The same measurement position was used when recording the optical response in both images. The measurement position was selected in an matrix area with a white state (black on white) in both images. In FIG. 6, the measured normalized optical response as a funtion of time at the measurement position for the respective image when using a refresh constant N₁=128 and N₂=256, respectively, is plotted together with a measurement of the complete label for N₂=256. Note the small modulation on the N=128 crosstalk scan in the plot. It is twice the frequency of the large modulation on the N=256 measurement. There is no visible crosstalk to the white on the label image. The modulation measured in the crosstalk image at N=256 is nearly 15% and therefore very visible, even for the white state. When reducing N by a factor of 2 the modulation is effectively zero and therefore invisible. The white modulation in the label image is near zero even for N=256. The image contains less black data above and below than the crosstalk image. The black state does show modulation in the label image for N=256 and there a lower value of N would still be necessary to reduce this artifact.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A method of driving a display of active matrix-type, the matrix including addressable pixels associated with lines L₁-L_{M} and columns of said matrix, said method comprising:
writing image data to said matrix utilizing a line timing LT determined by a preselected base frame rate BR and the number of lines M of the matrix;
determining an extended frame rate N-frame for addressing all pixels of the matrix; and
providing a preselected intermittent refresh IR by distributing the writing of image data to all pixels within a time period defined by said extended frame rate N-frame.

2. A method according to claim 1, wherein said extended frame rate N-frame is based on a preselected refresh constant N.

3. A method according to claim 2, wherein said extended frame rate N-frame is determined by the product of said refresh constant N and said base rate BR.

4. A method according to claim 1, wherein said extended frame rate N-frame is varied based on image data.

5. A method according to claim 4, wherein said refresh constant N is selected based on crosstalk associated with said image data.

6. A method according to claim 1, wherein said step of distributing writing of image data comprises:
addressing all lines L₁-Lₘ in sequence during a 1^{st} frame,
holding a predetermined number of frames defined by said refresh constant N, and then
refreshing said image data by addressing all lines L₁-L_{M} in sequence during an N^{th} frame.

7. A method according to claim 6, further comprising applying a quiescent state to driving electronics utilized for addressing the matrix during at least a portion of said step of holding.

8. A method according to claim 1, further comprising a step of determining a line clock time CKV, and wherein said step of distributing writing of image data comprises:
addressing all lines L₁-L_{M} in sequence, while waiting a number of line clock times CKVs determined by said refresh constant N before addressing a subsequent line.

9. A method according to claim 1, wherein said step of distributing writing of image data comprises:
dividing said matrix into NUN scan segments, and
for each successive frame
addressing a subsequent line of each scan segment until all lines have been addressed.

10. A method according to any preceding claim, further comprising utilizing frame inversion, column inversion, line inversion, or pixel inversion during said intermittent refresh.

11. A method according to claim 1, wherein said intermittent refresh is performed with a same polarity for a selected number of extended frames N-frame.

12. A method according to claim 1, wherein said intermittent refresh further comprises successive same polarity base frame rate pixel charging.

13. A method according to claim 12, wherein said successive base frame rate pixel charging is performed only in each inverting frame.

14. A method according to claim 8, further comprising successive base frame rate pixel charging, wherein a timing sequence for writing and refreshing of an n^{th} line is given by t=((n+x)N−x)CKV for x=0 to (x−1), wherein x is the number of refresh times of said n^{th} line.
